(19) United States
(12) Patent Application Publication
(10) Pub. No.: US 2010/0232432 A1
(43) Pub. Date: Sep. 16, 2010

(54) EXTENDED SAF PACKET TO SUPPORT VOLUMINOUS MEDIA DATA

(76) Inventors: Ye-Sun Joung, Daejeon-city (KR); Won-Sik Cheong, Daejeon-city (KR); KyungAe Moon, Daejeon-city (KR); JinWoo Hong, Daejeon-city (KR); Young-Kwon Lim, Gyeonggi-do (KR); JaeHong Park, Seoul (KR)

Correspondence Address: LADAS & PARRY LLP, 224 SOUTH MICHIGAN AVENUE, SUITE 1600, CHICAGO, IL, 60604, US

(21) Appl. No.: 12/294,967

(22) PCT Filed: Mar. 29, 2007
(86) PCT No.: PCT/KR2007/001534

§ 371 Date: Dec. 19, 2008

Related U.S. Application Data
(60) Provisional application No. 60/786,998, filed on Mar. 29, 2006.
(60) Provisional application No. 60/796,732, filed on May 2, 2006.
(60) Provisional application No. 60/816,784, filed on Jun. 27, 2006.

(30) Foreign Application Priority Data
Nov. 27, 2006 (KR) 10-2006-0117936

(51) Int. Cl. H04L 12/56

(52) U.S. Cl. 370/392

(57) ABSTRACT

Provided are an extended Simple Aggregation Format (SAF) packet to support voluminous media data and a method of generating the extended SAF packet. The extended SAF packet includes an SAF access unit including an SAF fragment unit obtained by dividing the voluminous media data into a data size suitable for transmission through an SAF packet and a field that provides information about the type of the SAF fragment unit, and an SAF packet header including a field that provides information about whether the SAF access unit carries the SAF fragment unit. Thus, it is indicated that the SAF packet carries the SAF fragment unit from information of the SAF packet header, and the type of the SAF fragment unit, a sequence number of the SAF fragment unit and a total access unit length from information of the SAF access unit.

### TECHNICAL FIELD

The present invention generally relates to a Simple Aggregation Format (SAF) packet, and more particularly, to an extended SAF packet to support voluminous data, an apparatus for generating an SAF packet, an apparatus for parsing an SAF packet and methods thereof.

### BACKGROUND ART

In Moving Picture Experts Group (MPEG)-4 Light Application Scene Representation (LASeR) for providing a simple multimedia service using a terminal having limited resources, such as a portable phone, the format of a packet during streaming is defined as a Simple Aggregation Format (SAF).

The SAF is the configuration of an MPEG-4 system synchronization layer that provides an easy but robust element stream packaging method capable of simply multiplexing various media, fonts, and scene streams as a simplified stream mechanism.

### DISCLOSURE OF INVENTION

### Technical Problem

A packet size allowable in a conventional SAF packet structure is limited to 65,535 bytes. Therefore, it is difficult to support voluminous media data used in mobile applications under rapid development. For example, voluminous media data such as pictures taken by a mobile device equipped with a high-pixel camera or Compact Multimedia Format (CMF) data used in 3GPP2 cannot be supported by the conventional SAF packet structure.

Therefore, there is a need for an extended SAF packet that is compatible with the conventional SAF packet structure and can support voluminous media data.

### Technical Solution

The present invention provides an extended Simple Aggregation Format (SAF) packet that can support voluminous multimedia data and is compatible with a conventional SAF packet.

The present invention also provides an apparatus for and method of generating an extended SAF packet that can support voluminous multimedia data and is compatible with a conventional SAF packet.

The present invention also provides an apparatus for and method of parsing an extended SAF packet that can support voluminous multimedia data and is compatible with a conventional SAF packet.

The present invention also provides a computer-readable recording medium having recorded thereon a program for implementing a method of generating and of parsing an extended SAF packet that can support voluminous multimedia data and is compatible with a conventional SAF packet.

### Advantageous Effects

According to the present invention, during transmission of an SAF fragment unit obtained by dividing voluminous media data through an SAF packet, when a value ‘0’ of an access unit length field used in a conventional SAF packet header is ‘0’, an SAF fragment unit or an SAF first fragment unit is transmitted transmitted in an SAF access unit. Thus, it is indicated that the SAF packet carries the SAF fragment unit of the voluminous media data, thereby allowing transmission of the voluminous media data.

Moreover, the SAF access unit includes a fragment sequence number, thereby preparing for a packet loss.

Furthermore, when the SAF packet includes the SAF first fragment unit constituting the first SAF packet, it contains information about a total access unit length, thereby allowing a decoder to calculate the total size of the media data.

In addition, since a reception side can receive the voluminous media data and recognize and prepare for a data loss from the field information of the SAF packet, a better quality service can be provided to users.

Therefore, the SAF packet according to the present invention is compatible with a LASeR version 1 and a conventional SAF packet and can be extended to support voluminous media data.

### DESCRIPTION OF DRAWINGS

FIG. 1 illustrates the structure of a Simple Aggregation Format (SAF) packet including an access unit length field according to an exemplary embodiment of the present invention;

FIG. 2 illustrates the structure of an SAF fragment unit of an SAF packet according to an exemplary embodiment of the present invention;

FIG. 3 illustrates the structure of a SAF first fragment unit of an SAF packet according to an exemplary embodiment of the present invention;

FIG. 4 illustrates access unit types of a payload in an SAF access unit of an SAF packet according to an exemplary embodiment of the present invention;

FIG. 5 is a block diagram of an apparatus for generating an SAF packet according to an exemplary embodiment of the present invention;

FIG. 6 is a flowchart of a method of generating an SAF packet according to an exemplary embodiment of the present invention;

FIG. 7 is a block diagram of an apparatus for parsing an SAF packet according to an exemplary embodiment of the present invention; and

FIG. 8 is a flowchart of a method of parsing an SAF packet according to an exemplary embodiment of the present invention.

### BEST MODE

According to one aspect of the present invention, there is provided an extended Simple Aggregation Format (SAF) packet to support voluminous media data. The extended SAF packet includes an SAF access unit including an SAF fragment unit obtained by dividing the voluminous media data into a data size suitable for transmission through an SAF packet and a field that provides information about the type of the SAF fragment unit and an SAF packet header including a field that provides information about whether the SAF access unit carries the SAF fragment unit.

The SAF access unit may further include a field that provides information about the total size of the voluminous media data if the type of the SAF fragment unit is an SAF first fragment unit that constitutes a first SAF packet. The SAF access unit may further include a field that provides information about a sequence number of the SAF fragment unit if the type of the SAF fragment unit is an SAF fragment unit that constitutes an SAF packet following a first SAF packet.

It may be indicated that the SAF fragment unit is carried in a payload of the SAF access unit by setting a value of the field of the SAF packet header to ‘0’.

According to another aspect of the present invention, there is provided an apparatus for generating an extended Simple Aggregation Format (SAF) packet to support voluminous media data. The apparatus includes an access unit generation unit generating an SAF access unit including an SAF fragment unit obtained by dividing the voluminous media data into a data size suitable for transmission through an SAF packet and a field that provides information about the type of the SAF fragment unit; and a header generation unit generating an SAF packet header including a field that provides information about whether the SAF access unit carries the SAF fragment unit.

According to another aspect of the present invention, there is provided a parsing apparatus which receives a Simple Aggregation Format (SAF) packet carrying media data and parses a field that provides media data information of the SAF packet, in which the SAF packet is an extended SAF packet to support voluminous media data. The extended SAF packet includes an SAF access unit including an SAF fragment unit obtained by dividing the voluminous media data into a data size suitable for transmission through the SAF packet and a field that provides information about the type of the SAF fragment unit, and an SAF packet header including a field that provides information about whether the SAF access unit carries the SAF fragment unit.

According to another aspect of the present invention, there is provided a method of generating an extended Simple Aggregation Format (SAF) packet to support voluminous media data. The method includes generating an SAF access unit including an SAF fragment unit obtained by dividing the voluminous media data into a data size suitable for transmission through an SAF packet and a field that provides information about the type of the SAF fragment unit, and generating an SAF packet header including a field that provides information about whether the SAF access unit carries the SAF fragment unit.

According to another aspect of the present invention, there is provided a parsing method which receives a Simple Aggregation Format (SAF) packet carrying media data and parses a field that provides media data information of the SAF packet, in which the SAF packet is an extended SAF packet to support voluminous media data. The extended SAF packet includes an SAF access unit including an SAF fragment unit obtained by dividing the voluminous media data into a data size suitable for transmission through the SAF packet and a field that provides information about the type of the SAF fragment unit, and an SAF packet header including a field that provides information about whether the SAF access unit carries the SAF fragment unit.

According to another aspect of the present invention, there is provided a computer-readable recording medium having recorded thereon a program for implementing any one of the methods of generating and parsing the extended SAF packet.

The above and other features and advantages of the present invention will become more apparent by describing in detail an exemplary embodiment thereof with reference to the attached drawings in which:

### Mode for Invention

Hereinafter, an exemplary embodiment of the present invention will be described in detail with reference to the accompanying drawings. It should be noticed that like reference numerals refer to like elements illustrated in one or more of the drawings. In the following description of the present invention, a detailed description of known functions and configurations incorporated herein will be omitted for conciseness and clarity.

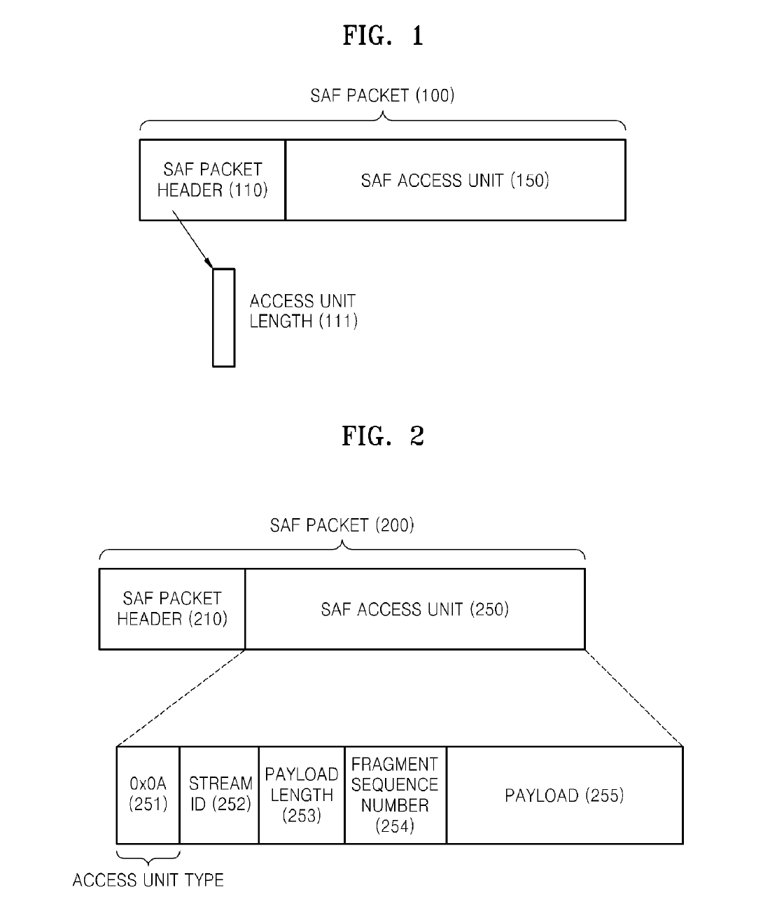

FIG. 1 illustrates the structure of a Simple Aggregation Format (SAF) packet 100 including an access unit length (accessUnitLength) field 111 according to an exemplary embodiment of the present invention.

Referring to FIG. 1, the SAF packet 100 includes an SAF packet header 110 and an

SAF access unit 150. Thus, the length of the SAF access unit 150 is equal to a difference between the length of the SAF packet 100 and the length of the SAF packet header 110.

According to the present invention, in order to transmit voluminous media data through an SAF packet, the voluminous media data is divided into a data size suitable for transmission through the SAF packet. In the present invention, each divided data is called an SAF fragment unit and an SAF fragment unit that constitutes a first unit of the SAF packet is called an SAF first fragment unit.

The SAF packet header 110 includes a field that provides information about whether the SAF access unit 150 carries an SAF fragment unit, and the SAF access unit 150 includes an SAF fragment unit and a field that provides information about the type of the SAF fragment unit.

The SAF fragment unit is carried in a payload of the SAF access unit 150.

The SAF packet header 110 includes the access unit length field 111.

Generally, the SAF packet is designed to be compatible with a Synchronization Layer (SL) packet in order to use a conventional transmission mechanism for transmission using an Internet Protocol (IP) such as RFP 3640. Thus, it is important to maintain such compatibility when a new feature is introduced to the SAF packet 100.

According to semantics of an SL packet header in Moving Picture Experts Group (MPEG)-4, the definition of an access unit length is as follows; accessUnitLength-is the length of an access unit in bytes. If this syntax element is not present or has the value ‘zero’, the length of the access unit is unknown.

Thus, since the value ‘zero’ does not mean the actual size of the access unit in a packet in an MPEG-4 system, it can be used to indicate a new feature introduced to the SAF packet 100 without chaining the semantics of an access unit length field.

Also, according to semantics of an SAF packet header in ISO/IEC 14496-20, the definition of an access unit length is as follows; accessUnitLength—is the length in bytes of an SAF access unit conveyed in an SAF packet. The value of this field shall be at least 2. Values ‘0’ and ‘1’ are reserved for future ISO use.

Therefore, for compatibility with a conventional SAF packet, the value ‘0’ or ‘1’ of the access unit length field can be used to indicate a new feature introduced to the SAF packet 100.

In the present invention, the SAF packet header 110 has the same structure as a conventional SAF packet header structure except that ‘0’ is used as a value of the access unit length field 111 to indicate that a payload of the SAF packet 100 carries fragment of voluminous multimedia data. In this way, the extended SAF packet according to the present invention is compatible with a conventional SAF packet.

FIG. 2 illustrates the structure of an SAF fragment unit of an SAF packet 200 according to an exemplary embodiment of the present invention. A detailed code is as follows:

class safFU {
bit(4) accessUnitType;
bit(12) streamID
bit(16) payloadLength;
bit(8) fragmentSeqNum;
byte(8) [payloadLength-1] payload;
}

Referring to FIG. 2, the SAF packet 200 includes an SAF packet header 210 and an SAF access unit 250. The SAF packet header 210 is the same as the SAF packet header 110 illustrated in FIG. 1 and thus will not be described herein. The SAF access unit 250 includes a payload field 255 that carries data of an SAF fragment unit, an access unit type field 251, a stream identifier (ID) field 252, a payload length field 253, and a fragment sequence number field 254.

The access unit type field 251 provides information about whether data carried in the

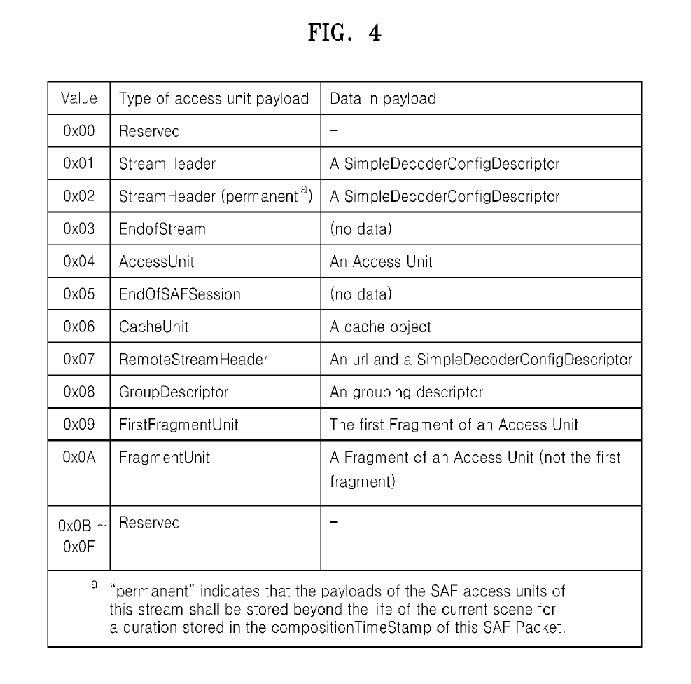

SAF packet corresponds to an SAF first fragment unit. Since an SAF packet illustrated in FIG. 2 carries the SAF fragment unit after the SAF first fragment unit, it can be seen from FIG. 4 showing access unit types and data types corresponding thereto that the access unit type (accessUnitType) field 251 has a value 0x0A (10).

A stream ID (streamID) of the stream ID field 252 indicates unique ID information of an element stream included in the current access unit. For example, for a video element stream, the stream ID may be a video element stream 1, 2, 3, or the like.

The payload length field 253 provides information about the length of a payload (payloadLength) carrying data. When an SAF access unit type is 0x0A, the length of a payload is equal to the size of the SAF fragment unit.

A fragment sequence number (fragmentSeqNum) of the fragment sequence number field 254 indicates a sequence number of an SAF fragment unit carried in the payload. The packet header 210 includes a field that provides information about a sequence number of an access unit (AU_Sequencenumber). The fragment sequence number is a serial number of transmission media data. In the present invention, voluminous media data as its entirety has a single access unit sequence number and SAF fragment units obtained by dividing the voluminous media data have the same access unit sequence number. Since the order of each of the SAF fragment units cannot be known from the access unit sequence number, there is no way to check a packet loss. Thus, by indicating the order of each of SAF fragment units obtained by dividing the voluminous media data carried in the payload using the fragment sequence number, a packet loss can be prepared for.

The payload field 255 corresponds to object data of an access unit and the length of the payload field 255 can be known from information of the payload length field 253.

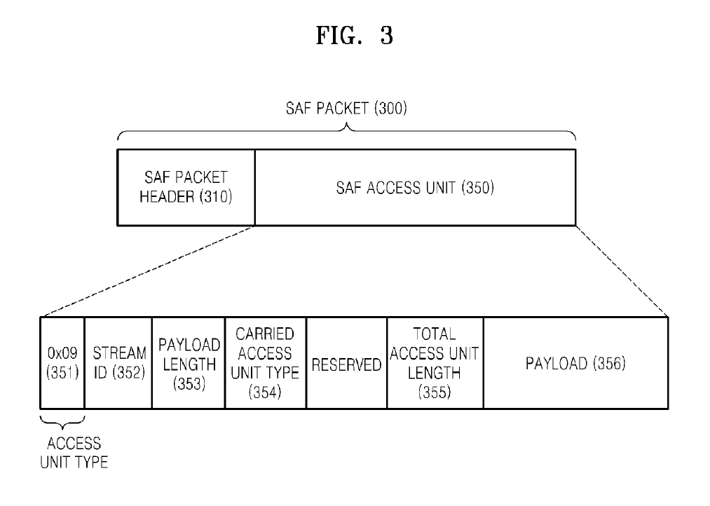

FIG. 3 illustrates the structure of a SAF first fragment unit of an SAF packet 300 according to an exemplary embodiment of the present invention. A detailed code is as follows.

class safFFU {
bit(4) accessUnitType;
bit(12) streamID;
bit(16) payloadLength;
bit(4) carriedAccessUnitType;
bit(4) reserved;
bit(32) totalLengthOfAccessUnit;
byte(8) [payloadLength-5] payload;
}

Referring to FIG. 3, the SAF packet 300 includes an SAF packet header 310 and an

SAF access unit 350. The SAF packet header 310 is the same as the SAF packet header 110 illustrated in FIG. 1 and thus will not be described herein. The SAF access unit 350 includes a payload field 356 that carries data of an SAF fragment unit, an access unit type field 351, a stream ID field 352, a payload length field 353, a carried access unit type field 354, and a total access unit length field 355.

The access unit type field 351 provides information about whether data carried in the

SAF packet corresponds to an SAF first fragment unit. Since an SAF packet illustrated in FIG. 3 carries the SAF first fragment unit, it can be seen from FIG. 4 showing access unit types and data types corresponding thereto that the access unit type (accessUnitType) field 351 has a value 0x09 (9).

A stream ID (streamID) of the stream ID field 352 indicates unique ID information of an element stream included in the current access unit. For example, for a video element stream, the stream ID may be a video element stream 1, 2, 3, or the like.

The payload length field 353 provides information about the length of a payload (payloadLength) carrying data. When an SAF access unit type is 0x09, the length of a payload is equal to the size of the SAF first fragment unit.

A carried access unit type (carriedAccessUnitType) of the carried access unit type field 354 indicates the type of a fragment carried in a payload and referring to FIG. 4, may be a simple decoder configuration descriptor Simple Decoder ConfigDescriptor), an end of stream (EndOfStream), an access unit of element streams, an end of an SAF session (EndOfSAFSession), a cache unit, or the like.

A total access unit length (totalLengthOfAccessUnit) of the total access unit length field 355 indicates a sum of the lengths of SAF fragment units obtained by dividing transmission voluminous media data. Thus, the total access unit length is the total size of transmission voluminous media data. Thus, information about how much data has to be transmitted after the SAF first fragment unit can be obtained from information of the SAF first fragment unit.

The payload field 356 corresponds to object data of an access unit and the length of the payload field 356 can be known from information of the payload length field 353.

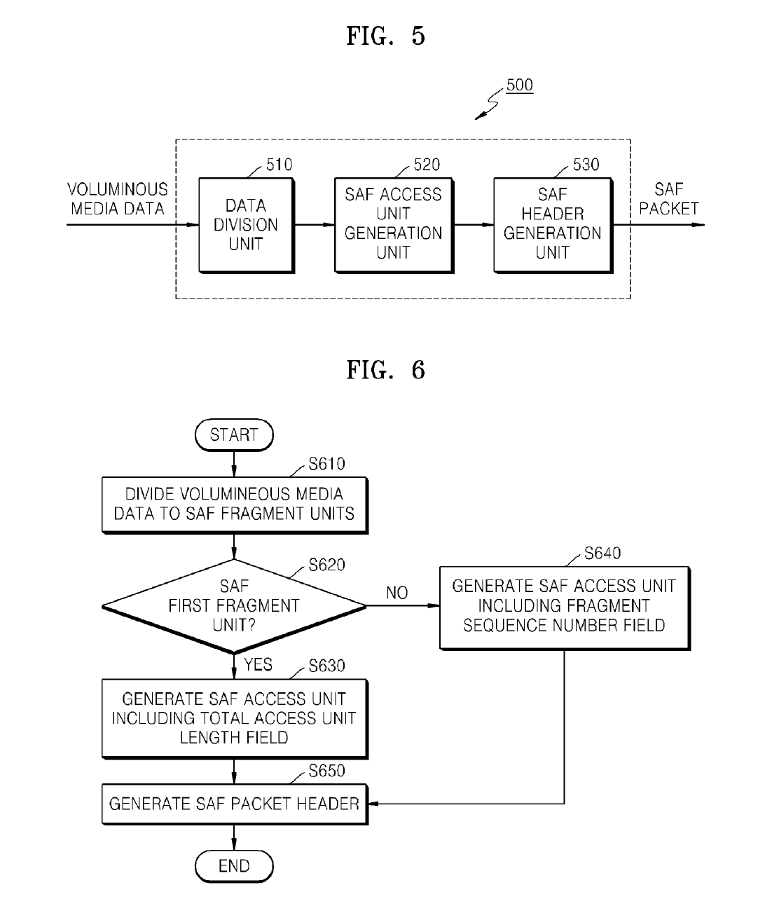

FIG. 5 is a block diagram of an apparatus 500 for generating an SAF packet according to an exemplary embodiment of the present invention.

The apparatus 500 includes a data division unit 510, an access unit generation unit 520, and a header generation unit 530.

The data division unit 510 receives voluminous media data and configures SAF fragment units by dividing the media data into a data size suitable for transmission through an SAF packet. The SAF fragment unit can be classified into one of two types: an SAF first fragment unit constituting a first SAF packet or an SAF fragment unit constituting an SAF packet following the first SAF packet.

The access unit generation unit 520 carries an SAF fragment unit in a payload and determines whether the type of the current SAF fragment unit is an SAF first fragment unit in order to generate an access unit type field that provides information about the type of the current SAF fragment unit.

If the type of the SAF fragment unit is the SAF first fragment unit, the access unit generation unit 520 further generates a total access unit length field that provides information about the total size of the voluminous media data. If the type of the SAF fragment unit is an SAF fragment unit that constitutes an SAF packet following the first SAF packet, the access unit generation unit 520 further generates a fragment sequence number field that provides information about a sequence number of the SAF fragment unit. By checking the sequence number, a packet loss can be prepared for.

The header generation unit 530 generates an SAF packet header including a field that provides information about whether the generated SAF access unit carries the SAF fragment unit. The SAF packet header uses an access unit length field included in a conventional SAF packet header. Thus, it can be indicated that the SAF fragment unit is carried in the payload of the SAF access unit by setting a value of the access unit length field to ‘0’.

FIG. 6 is a flowchart of a method of generating an SAF packet according to an exemplary embodiment of the present invention.

The method includes generating an SAF access unit including an SAF fragment unit and a field that provides information about the type of the SAF fragment unit and generating an SAF packet header including a field that provides information about whether the SAF access unit carries the SAF fragment unit.

More specifically, in operation S610, voluminous media data is divided into a data size suitable for transmission through an SAF packet, thereby configuring SAF fragment units.

In operation S620, it is determined whether an SAF fragment unit included in an SAF access unit is an SAF first fragment unit that constitutes a first SAF packet.

If the SAF fragment unit is the SAF first fragment unit, a total access unit length field that provides information about the total size of the media data is generated in operation S630, thereby allowing a decoder to calculate the total size of the media data.

If the SAF fragment unit is not the SAF first fragment unit, a fragment sequence number field that provides information about a sequence number of the SAF fragment unit in operation S640, thereby preparing for a packet loss.

And the fields that provide information about a payload are added to the SAF access unit. And then SAF packet header including an access unit length field is generated in operation S650. A value of the access unit length field is set to ‘0’ for compatibility with an SL structure of an MPEG-4 system. The set value ‘0’ indicates that the SAF fragment unit or the SAF first fragment unit is carried in the payload of the SAF access unit rather than indicates the access unit length. Thus, the extended SAF packet according to the present invention can carry voluminous media data while keeping compatibility with a conventional SAF packet.

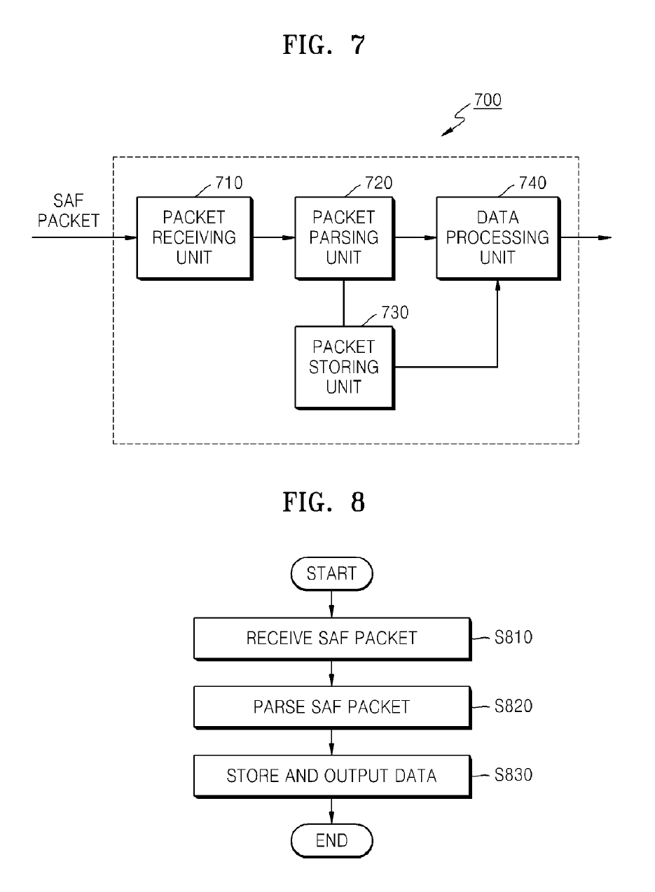

FIG. 7 is a block diagram of an apparatus 700 for parsing an extended SAF packet according to an exemplary embodiment of the present invention.

Referring to FIG. 7, the apparatus 700 includes a packet receiving unit 710, a packet parsing unit 720, a data storing unit 730, and a data processing unit 740.

The packet receiving unit 710 receives an extended SAF packet including an SAF access unit and an SAF packet header to support voluminous media data. The SAF access unit includes an SAF fragment unit obtained by dividing the media data into a data size suitable for transmission through an SAF packet and a field that provides information about the type of the SAF fragment unit. The SAF packet header includes a field that provides information about whether the SAF access unit carries the SAF fragment unit.

The packet parsing unit 720 parses the field of the received SAF packet to determine whether the SAF packet carries the voluminous media data and recognizes the total size of the voluminous media data and whether a data loss occurs during transmission.

The data storing unit 730 stores the parsed field information and the transmitted voluminous media data.

The data processing unit 740 processes and outputs information of the packet parsing unit 720 and data of the data storing unit 730 in a predetermined way corresponding to a data type.

FIG. 8 is a flowchart of a method of parsing an extended SAF packet according to an exemplary embodiment of the present invention.

Referring to FIG. 8, an extended SAF packet including an SAF access unit and an SAF packet header to support voluminous media data is received in operation S810. The SAF access unit includes an SAF fragment unit obtained dividing the media data into a data size suitable for transmission through an SAF packet and a field that provides information about the type of the SAF fragment unit.

The received SAF packet is parsed in order to determine whether the received SAF packet carries the voluminous media data and the total size of the media data and whether a data loss occurs during transmission from the field information in operation S820.

The transmitted media data is stored and information obtained by the parsing and stored data are processed and output in a predetermined way corresponding to a data type in operation S830.

Since voluminous media data can be received and a data loss can be prepared for, a better quality service can be provided to users.

Meanwhile, the present invention can also be embodied as computer-readable code on a computer-readable recording medium. The computer-readable recording medium is any data storage device that can store data which can be thereafter read by a computer system. Examples of computer-readable recording media include read-only memory (ROM), random-access memory (RAM), CD-ROMs, magnetic tapes, floppy disks, optical data storage devices, and carrier waves. The computer-readable recording medium can also be distributed over a network of coupled computer systems so that the computer-readable code is stored and executed in a decentralized fashion. Functional programs, code, and code segments for implementing the present invention can be easily construed by those of ordinary skill in the art. The structure of the SAF packet according to the present invention may also be implemented as computer-readable code on a computer-readable recording medium such as ROM, RAM, CD-ROMs, magnetic tapes, floppy disks, optical data storage devices, and the like.

While the present invention has been particularly shown and described with reference to an exemplary embodiment thereof, it will be understood by those of ordinary skill in the art that various changes in form and detail may be made therein without departing from the spirit and scope of the present invention as defined by the following claims.

1. An extended Simple Aggregation Format (SAF) packet to support voluminous media data, the extended SAF packet comprising:
an SAF access unit including an SAF fragment unit obtained by dividing the voluminous media data into a data size suitable for transmission through an SAF packet and a field that provides information about the type of the SAF fragment unit; and
an SAF packet header including a field that provides information about whether the SAF access unit carries the SAF fragment unit.

2. The extended SAF packet of claim 1, wherein the SAF access unit further includes a field that provides information about the total size of the voluminous media data if the type of the SAF fragment unit is an SAF first fragment unit that constitutes a first SAF packet.

3. The extended SAF packet of claim 1, wherein the SAF access unit further includes a field that provides information about a sequence number of the SAF fragment unit if the type of the SAF fragment unit is an SAF fragment unit that constitutes an SAF packet following a first SAF packet.

4. The extended SAF packet of claim 1, wherein it is indicated that the SAF fragment unit is carried in a payload of the SAF access unit by setting a value of the field of the SAF packet header to ‘0’.

5. An apparatus for generating an extended Simple Aggregation Format (SAF) packet to support voluminous media data, the apparatus comprising:
an access unit generation unit generating an SAF access unit including an SAF fragment unit obtained by dividing the voluminous media data into a data size suitable for transmission through an SAF packet and a field that provides information about the type of the SAF fragment unit; and
a header generation unit generating an SAF packet header including a field that provides information about whether the SAF access unit carries the SAF fragment unit.

6. The apparatus of claim 5, wherein the access unit generation unit further generates a field that provides information about the total size of the voluminous media data if the type of the SAF fragment unit is the SAF first fragment unit.

7. The apparatus of claim 5, wherein the access unit generation unit further generates a field that provides information about a sequence number of the SAF fragment unit if the type of the SAF fragment unit is an SAF fragment unit that constitutes an SAF packet following the first SAF packet.

8. The apparatus of claim 5, wherein the header generation unit indicates that the SAF fragment unit is carried in a payload of the SAF access unit by setting a value of the field of the SAF packet header to ‘0’.

9. A parsing apparatus which receives a Simple Aggregation Format (SAF) packet carrying media data and parses a field that provides media data information of the SAF packet,
wherein the SAF packet is an extended SAF packet to support voluminous media data, the extended SAF packet comprising:
an SAF access unit including an SAF fragment unit obtained by dividing the voluminous media data into a data size suitable for transmission through the SAF packet and a field that provides information about the type of the SAF fragment unit; and
an SAF packet header including a field that provides information about whether the SAF access unit carries the SAF fragment unit.

10. The parsing apparatus of claim 9, wherein the SAF access unit further includes a field that provides information about the total size of the voluminous media data if the type of the SAF fragment unit is an SAF first fragment unit that constitutes a first SAF packet.

11. The parsing apparatus of claim 9, wherein the SAF access unit further includes a field that provides information about a sequence number of the SAF fragment unit if the type of the SAF fragment unit is an SAF fragment unit that constitutes an SAF packet following a first SAF packet.

12. The parsing apparatus of claim 9, wherein it is indicated that the SAF fragment unit is carried in a payload of the SAF access unit by setting a value of the field of the SAF packet header to ‘0’.

13. A method of generating an extended Simple Aggregation Format (SAF) packet to support voluminous media data, the method comprising:
generating an SAF access unit including an SAF fragment unit obtained by dividing the voluminous media data into a data size suitable for transmission through an SAF packet and a field that provides information about the type of the SAF fragment unit; and
generating an SAF packet header including a field that provides information about whether the SAF access unit carries the SAF fragment unit.

14. The method of claim 13, wherein the generating of the SAF access unit further comprises generating a field that provides information about the total size of the voluminous media data if the type of the SAF fragment unit is the SAF first fragment unit.

15. The method of claim 13, wherein the generating of the SAF access unit further comprises generating a field that provides information about a sequence number of the SAF fragment unit if the type of the SAF fragment unit is an SAF fragment unit that constitutes an SAF packet following the first SAF packet.

16. The method of claim 13, wherein the generating of the SAF packet header comprises indicating that the SAF fragment unit is carried in a payload of the SAF access unit by setting a value of the field of the SAF packet header to ‘0’.

17. A parsing method which receives a Simple Aggregation Format (SAF) packet carrying media data and parses a field that provides media data information of the SAF packet,
wherein the SAF packet is an extended SAF packet to support voluminous media data, the extended SAF packet comprising:
an SAF access unit including an SAF fragment unit obtained by dividing the voluminous media data into a data size suitable for transmission through the SAF packet and a field that provides information about the type of the SAF fragment unit; and
an SAF packet header including a field that provides information about whether the SAF access unit carries the SAF fragment unit.

18. The parsing method of claim 17, wherein the SAF access unit further includes a field that provides information about the total size of the voluminous media data if the type of the SAF fragment unit is an SAF first fragment unit that constitutes a first SAF packet.

19. The parsing method of claim 17, wherein the SAF access unit further includes a field that provides information about a sequence number of the SAF fragment unit if the type of the SAF fragment unit is an SAF fragment unit that constitutes an SAF packet following a first SAF packet.

20. The parsing method of claim 17, wherein it is indicated that the SAF fragment unit is carried in a payload of the SAF access unit by setting a value of the field of the SAF packet header to ‘0’.

21. A computer-readable recording medium having recorded thereon a program for implementing any one of the method of claims 13 through 20.
